(19) United States
(12) Patent Application Publication
(10) Pub. No.: US 2016/0264485 A1
(43) Pub. Date: Sep. 15, 2016

(54) COMPOST INJECTION APPARATUS

(71) Applicant: Jess Matthew Mayes, San Antonio, TX (US)

(72) Inventor: Jess Matthew Mayes, San Antonio, TX (US)

(21) Appl. No.: 14/656,608

(22) Filed: Mar. 12, 2015

(51) Int. Cl. C05F 17/02; B01F 15/02; B01F 3/04

(52) U.S. Cl. CPC C05F 17/027; B01F 3/04248; B01F 3/04255; B01F 15/026; B01F 3/04262; B01F 2215/0054

(57) ABSTRACT

A compost injection apparatus for aerating, infusing, and otherwise dispersing substances into a compost stacks. The compost injection apparatus comprises a T-shaped member having an elongated shaft section having a spiked distal end, proximal end integral with a handle section, and a plurality of injection holes along its length. The shaft section and handle section each define hollow pipe components adapted to form a continuous inner channel that spans the shaft section and handle section. The handle portion includes two input attachments through which pressurized liquid and gas can be introduced. Such pressurized liquid and gas can be introduced directly into the center of a compost stack by inserting the shaft section into the stack with the liquid or gas flowing through the compost injection apparatus and out of the injection holes.

### BRIEF DESCRIPTION OF THE DRAWINGS

FIG. 1 is a top perspective view of a compost injection apparatus built in accordance the present invention.

FIG. 2 is a bottom perspective view of an elongated shaft of the detachable shaft embodiment of a compost injection apparatus built in accordance the present invention.

FIG. 3 is a partial side perspective view of an elongated shaft of the offset injection hole embodiment of a compost injection apparatus built in accordance the present invention.

### DETAILED DESCRIPTION OF THE INVENTION

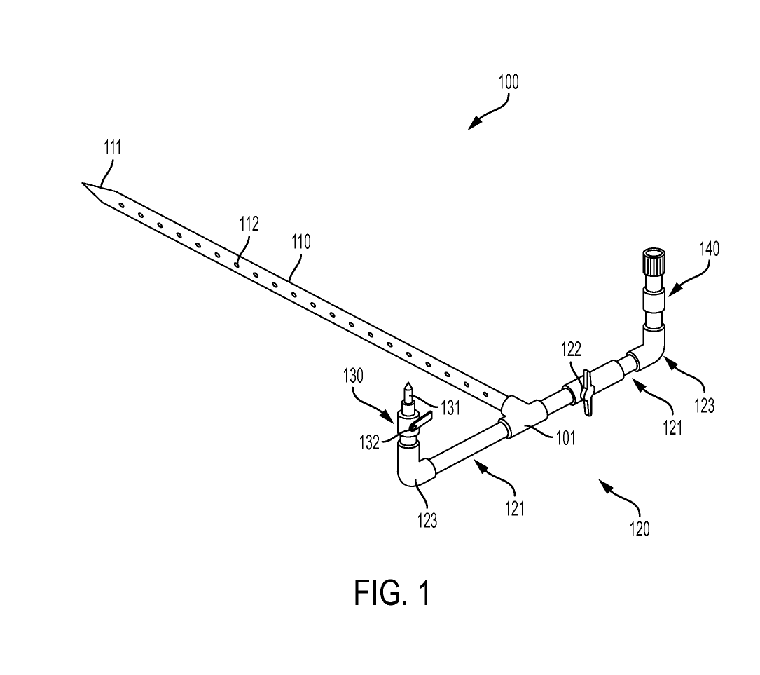

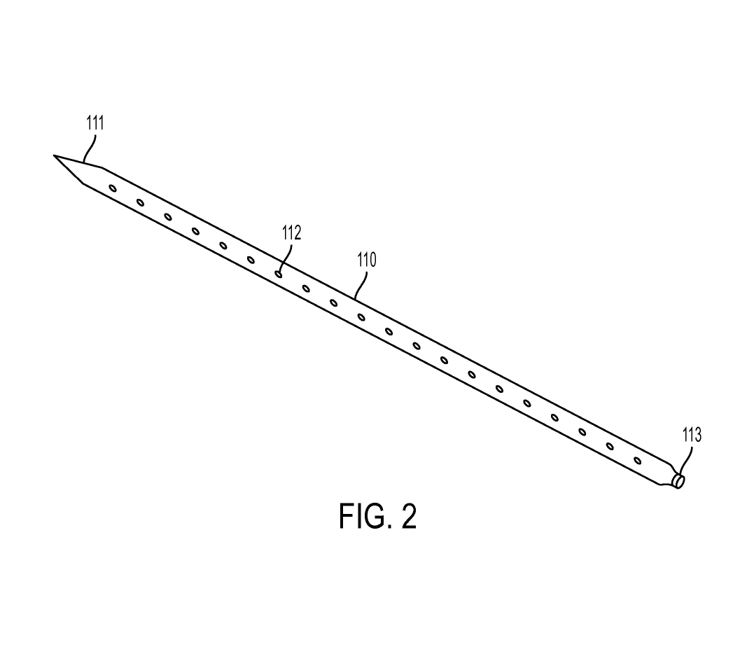

Referring now to the drawings and in particular FIGS. 1, 2, and 3, a compost injection apparatus 100 is shown as a T-shaped member having an elongated shaft section 110 having a distal end and proximal end and integral with a handle section 120. The shaft section 110 and handle section 120 each define hollow pipe components, with the central area of the handle section 120 attached to the proximal end of the shaft section 110 in a perpendicular orientation such that a continuous inner channel that spans the shaft section 110 and handle section 120 is formed. In the preferred embodiment, the shaft section 110 measures 48″ in length and is constructed of ¾″ PVC while the handle section 120 measures 18″ in length and is constructed of ¾″ PVC. It is contemplated, however, that in alternate embodiments the shaft section 110 and handle section 120 may be constructed of any suitable piping material, such as stainless steel, copper pipe, or galvanized pipe. It is additionally contemplated that the shaft section 110 and handle section 120 may be produced in larger or smaller sizes.

The shaft section 110 has a cylindrical body defined by a substantially smooth exterior surface with a spike member 111 disposed at its distal end and a threaded engagement portion 113 at its proximal end. Dispersed along the body of shaft section 110 are a plurality of injection holes 112, each defining an aperture in the shaft section 110. In this regard, the shaft section 110, with its spike member 111 at the end of a cylindrical body having a plurality of injection holes 112, provides a shaft means for injecting material into compost material.

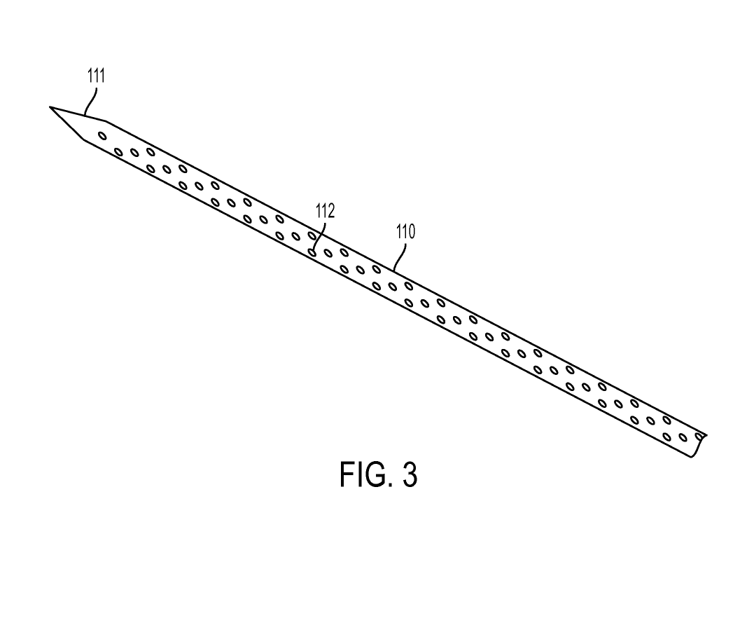

In an offset injection hole embodiment, the plurality of injection holes 112 are oriented in four discrete columns, with the respective columns running in parallel with one another in positions that are 90 degrees apart on the shaft section 110. Each injection hole 112 defines a 1/16″ aperture, with the column defining injection holes 112 linearly aligned and spaced 3″ inches apart. In such an embodiment, the injection holes 112 in different columns are offset so that the injection holes 112 in opposing columns (180 degrees apart) are directly across from one another while the injection holes 112 in adjacent columns (90 degrees apart) are positioned midway between the injection holes 112 one another (as illustrated by FIG. 3).

In another embodiment, the plurality of injection holes 112 are organized in two discrete longitudinal columns, with the respective columns running in parallel with one another in positions that are 180 degrees apart on the shaft section 110. Each injection hole 112 defines a 1/16″ aperture, with the column defining injection holes 112 linearly aligned and spaced 2″ inches apart.

In the preferred embodiment, the first injection hole 112 in its respective column is positioned 10″ from the proximal end of the shaft section 110.

It is contemplated, however, that the injection holes 112 may be placed in alternate orientations and positions on the shaft section 110.

In one embodiment, the shaft section 110 is attached to the handle section 120 with a tee fitting 101. It is contemplated that the engagement portion 113 enables the shaft section 110 to be selectively attached and detached to the tee fitting 101. It is understood that in such detachable embodiments, the tee fitting 101 includes a corresponding threaded portion (not shown) to receive and engage the threads on the shaft section 110.

The handle section 120 defines two handle components 121, which each extend from the tee 101 fitting in opposing directions on a perpendicular plane relative to the shaft section 110. When the handle section defines two discrete handle components 121, each handle component 121 includes an elbow fitting 123 and either a conventional compressed gas input attachment 130 or a liquid input attachment 140 (referred to collectively herein as “input attachment”). On the handle component 121 having the liquid input attachment 140, a cutoff valve 122 is included to provide manual control of liquid flow. Accordingly, the handle section 120 provides a handle means for receiving a plurality of discrete sources of pressurized fluid and directing such fluid into the shaft section 110.

In the illustrated embodiment, the tee fitting 101 defines a ¾″ tee fitting, with the handle component 121 that extends in one direction therefrom having the gas input attachment 130 including a first ¾″ connective pipe, then the elbow fitting 123 and the gas input attachment 130. The handle component 121 having the liquid input attachment 140 extends in the opposite direction and includes a second ¾″ connective pipe, then the cutoff valve 122 embodied as a ¾″ cutoff valve, followed by a third ¾″ connective pipe and the elbow fitting 123, and the liquid input attachment 140.

The gas input attachment 130 defines a compressed air inlet member 131 and an air pressure valve 132. In the preferred embodiment, the compressed air inlet member 131 is defined by a conventional ¼″ male swivel air inlet fitting and the air pressure valve 132 defines a conventional ¼″ air flow control valve. In this regard, it is contemplated that by connecting a conventional air compressor (not shown) to the compressed air inlet member 131, compressed air is introduced to the compost injection apparatus 100 and routed through the gas input attachment 130 to the handle component 121 attached thereto, and then through the shaft member 110 where it is released through the injection holes 112. The blast injection of air is controlled by the air pressure valve 132.

The liquid input attachment 140 defines a ¾″ female hose thread adapter. Through the connection of a conventional water hose (not shown), such as a garden hose or commercial liquid dispensing hoses, to the liquid input attachment 140, pressurized liquid is introduced to the compost injection apparatus 100 and routed through the liquid input attachment 140 to the handle component 121 attached thereto, and then through the shaft member 110 where it is released through the injection holes 112. Similar to the handle component 121 attached to the gas input attachment 130, the cutoff valve 122 on the handle component 121 attached to the liquid input attachment 140 allows for manual control of the flow of liquid to be directed into the shaft member 110.

It is well established that hot compost provides a sustainable and environmentally friendly form of solid waste reduction as anything organic can be broken down into rich soil in this manner. Typically, when a compost pile or stack is initially set up, the pile will then heat up to approximately 160 degrees in the first few days. Over time, however, it must maintain a steady oxygen and moisture supply in order to maintain this desired temperature. Otherwise, it may become anaerobic and produce an end product that is not safe or marketable. Thus, it is well known that the frequent re-introduction of moisture and oxygen enables the stack to stabilize at a higher temperature for extended periods and results in a drastically reduced time needed to complete the composting and produce a user product.

Accordingly, composting stacks of material typically entails mixing the desired materials, soaking them with water, and flipping and re-soaking the mixture numerous times over the course of months. Advantageously, the compost injection apparatus 100 is operative to enable a user to aerate, infuse, and moisten “hot” or “active” compost stacks (or piles) in a manner which reduces costs, labor and fuel requirements. Current practices of providing moisture to a compost stack often include presoaking the material in a large vat and then openly spraying significant amounts of water (enough to moisten the center of the stack) on the stack multiple times throughout the composting process. Conversely, the compost injection apparatus 100 is adapted to receive compressed water through a conventional hose connected to its liquid input attachment 140 and inject this water directly into the microbial and chemically active core of the stack by repeatedly inserting the shaft section 110, with water exiting from its injection holes 112, into the stack.

Similarly, the compost injection apparatus 100 is adapted to receive compressed gas, such as oxygen, through a conventional air compressor connected to its gas input attachment 130 and inject this gas directly into the microbial and chemically active core of the stack by repeatedly inserting the shaft section 110, with the gas exiting from its injection holes 112, into the stack. At present, conventional methods of providing aeration to a stack involves using heavy machinery and manual labor to manually flip the stack a plurality of times.

As a result, the compost injection apparatus 100 enables the re-introduction of oxygen and water for maintaining of optimal levels of oxygen moisture in an active compost stack without requiring open spraying of the stack or the flipping of the stack. It therefore allows huge amounts of water to be saved, prevents significant undesired runoff and waste, and reduces the requisite frequency of moisture re-introduction. Furthermore, because a fast rate of break down can be maintained, methane reductions and faster removal of municipal waste can be achieved.

It is contemplated that in alternate embodiments, a compost injection apparatus in accordance with the present invention can be scaled to a larger size by adding piping, additional shaft sections, more injection holes, and larger fittings. It is additionally contemplated that a larger embodiment of the compost injection apparatus may be mounted on a tractor, bulldozer, or forklift for maintenance of larger piles.

It is further contemplated that in some embodiments, the shaft section is detachable from the handle section. In such embodiments, the shaft section may include a male threaded section on its proximal end that removably attaches to a female threaded section on the tee fitting. It is appreciated that such an embodiment enables a user to selectively employ various shaft sections for different purposes, such as longer shaft sections in some instances and shorter shaft section in other instances.

It is appreciated that in addition or alternative to injecting water, a user can inject a Nitrogen, Phosphorus, Potassium mixture or other liquid minerals to create end products having alternate or defined compositions by connecting a container housing the same to at least one of said input attachments. In the same manner, it is further appreciated that liquids or gases containing additional microbes, such as fungi and bacteria, or liquid nutrients may be injected through the compost injection apparatus.

It is understood that the compost injection apparatus may additionally be configured with two gas input attachments 130 and no liquid input attachments 140, two liquid input attachments 140 and no gas input attachments 130, or in larger embodiments, any number of gas input attachments 130 and liquid input attachments 140.

It is additionally contemplated that in some embodiments, the handle section may define a single handle component having a cut off valve for each input apparatus attached thereon and attached to the shaft section through a fitting. Similarly, it is contemplated that in some embodiments, the handle section may define three or more handle components, each having a cut off valve for each input apparatus attached thereon and attached to the shaft section through a fitting.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. A compost injection apparatus for aerating, infusing, and otherwise dispersing substances into compost, comprising:
at least one elongated, hollow shaft section having a proximal end and a distal end, wherein said shaft section is adapted to be inserted into compost material and includes at least one injection hole therein;
a hollow handle section attached to the proximal end of the shaft section such that such that a continuous interior channel formed between the shaft section and handle section; and
at least one input attachment integral with said handle section, wherein said input attachment is configured to receive pressurized fluid material, so as to cause such fluid material to be directed through the interior channel to be released through the at least one injection hole.

2. The compost injection apparatus of claim 1, wherein a plurality of input attachments are integral with said handle section.

3. The compost injection apparatus of claim 2, wherein each of said input attachments are configured to receive a distinct pressurized fluid material.

4. The compost injection apparatus of claim 1, wherein said at least one input attachments define a discrete gas input attachment and a discrete liquid input attachment.

5. The compost injection apparatus of claim 4, wherein the gas input attachment includes a compressed air inlet member and an air pressure valve, said air pressure valve operative to control the blast injection of air.

6. The compost injection apparatus of claim 1, wherein the handle section includes a cutoff valve associated with each of the at least one input attachment, said cutoff valve operative to provide a manual control of the flow of fluid from the associated input attachment through the interior channel.

7. The compost injection apparatus of claim 1, wherein the handle section is defined by two handle components, each associated with a single input attachment.

8. The compost injection apparatus of claim 7, wherein each of said handle components are connected to the shaft section through a tee fitting.

9. The compost injection apparatus of claim 1, wherein said shaft section includes a plurality of injection holes arranged in at least one longitudinal column.

10. The compost injection apparatus of claim 1, wherein said shaft section is adapted to be inserted into compost material through a spike member disposed at the distal end and its substantially smooth exterior surface that limits friction.

11. A compost injection apparatus for aerating, infusing, and otherwise dispersing substances into compost, comprising:
at least one elongated, hollow shaft section having a proximal end and a distal end, wherein said shaft section includes a plurality of injection holes therein and a spike member disposed at the distal end;
a hollow handle section removably attached to the proximal end of the shaft section such that such that a continuous interior channel formed between the shaft section and handle section; and
a plurality of input attachment integral with said handle section, wherein each input attachment is configured to receive pressurized fluid material so as to cause such fluid material to be directed through the interior channel and be released through the at least one injection hole.

12. The compost injection apparatus of claim 11, wherein the handle section includes a cutoff valve associated with at least one of the input attachments, said cutoff valve operative to provide a manual control of the flow of fluid from the associated input attachment through the interior channel.

13. The compost injection apparatus of claim 12, wherein at least two of said input attachments are configured to receive a distinct pressurized fluid material.

14. The compost injection apparatus of claim 12, wherein at least one of said input attachments define a discrete gas input attachment and at least one of said input attachments define a discrete liquid input attachment.

15. The compost injection apparatus of claim 14, wherein the gas input attachment includes a compressed air inlet member and an air pressure valve, said air pressure valve operative to control the blast injection of air.

16. The compost injection apparatus of claim 12, wherein the handle section is defined by two handle components, each associated with a single input attachment.

17. The compost injection apparatus of claim 12, wherein said shaft section includes a plurality of injection holes arranged in at least one longitudinal column.

18. The compost injection apparatus of claim 17, wherein said shaft section includes a plurality of injection holes arranged in a first longitudinal column, a second longitudinal column, a third longitudinal column and a fourth longitudinal column, with the holes of the first longitudinal column and third longitudinal column is aligned 180 degrees from one another and offset 90 degrees from the holes of the second longitudinal column and fourth longitudinal column.

19. The compost injection apparatus of claim 17, wherein said shaft section includes a plurality of injection holes arranged in a first longitudinal column and a plurality of injection holes arranged in a second longitudinal column that is positioned 180 degrees from the first longitudinal column.

20. A compost injection apparatus for aerating, infusing, and otherwise dispersing substances into compost, comprising:
a shaft means for injecting material into compost material; and
a handle means for receiving a plurality of discrete sources of pressurized fluid and directing such fluid into the shaft means, wherein said handle means and said shaft means are configured such that pressurized fluid introduced to the handle means is selectively directed into said shaft means for release therefrom.
